(19) United States
(12) Patent Application Publication
(10) Pub. No.: US 2010/0269045 A1
(43) Pub. Date: Oct. 21, 2010

(54) DIGITAL DISPLAY TERMINAL AND METHOD FOR PROVIDING USER INTERFACE THEREON

(75) Inventors: Liang-Mao Hung, Tu-Cheng (TW); Chun-Wen Wang, Tu-Cheng (TW); Tun-Tao Tsai, Tu-Cheng (TW); Chi-Fan Ho, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Taipei Hsien (TW)

(21) Appl. No.: 12/485,319

(22) Filed: Jun. 16, 2009

(30) Foreign Application Priority Data
Apr. 16, 2009 (CN) 200910301591.5

(51) Int. Cl. G06F 3/01

(52) U.S. Cl. 715/738

(57) ABSTRACT

A digital display terminal is connected to a first content server and a second content server. The digital display terminal includes a display and a user interface module. The user interface module is capable of displaying first digital content and a second shortcut on a first page of an interactive user interface shown on the display. The second shortcut links to second digital content. The first digital content is stored in a first content server, and the second digital content is stored in a second content server.

### BACKGROUND

1. Technical Field

The invention generally relates to digital display terminals and a method for providing interactive user interface thereon facilitating user operation.

2. Description of Related Art

Digital display terminals relate to smart displaying devices providing received digital content from remote or local servers, such as digital media players (DMP), televisions, and others. In operation of these digital display terminals, selection of a specific server may be required before accessing the source thereon. A server menu may be provided before the content or service thereon becomes available. After the server is chosen, the content thereon is displayed. Server selection from the menu is again required when accessing another server.

### BRIEF DESCRIPTION OF THE DRAWINGS

FIG. 1 is a front view of a digital display terminal, with a first page of user interface displayed thereon.

FIG. 2 is a schematic view of a second page of a user interface of the digital display terminal.

FIG. 3 is a flowchart of a method for providing a user interface on a digital display terminal.

### DETAILED DESCRIPTION

A digital display terminal includes a display 10, user interface module (not shown) generating a user interface on the display 10, and a user input module 30 accepting input to the user interface. The user interface module may include a storage component for storing a user interface program and a processing component for processing the user interface program. The user input module 30 may include two or more direction keys accepting input to the user interface in a selection matrix. The user input module 30 may be integrated in the digital display terminal or on a remote control (not shown).

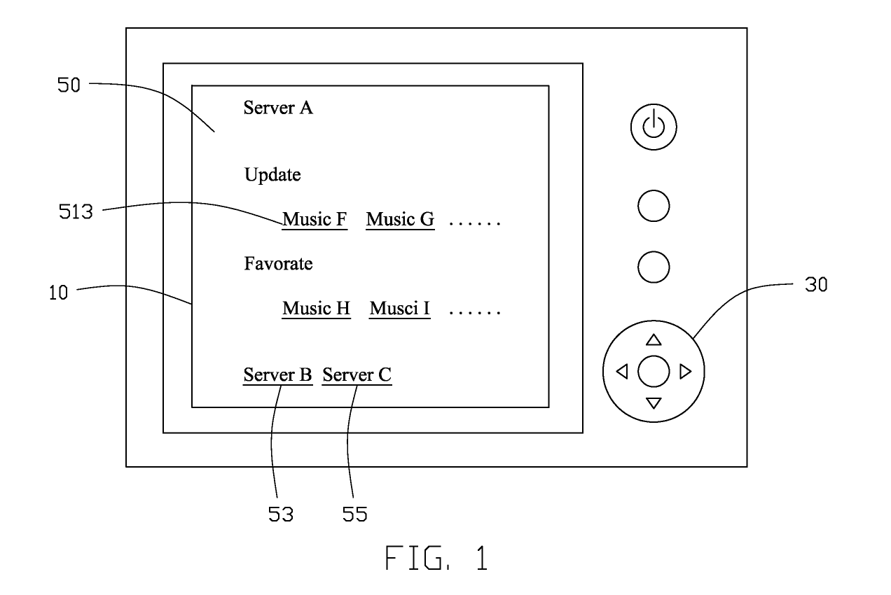

The digital display terminal is connected to the Internet as a digital terminal for receiving and displaying digital content from remote content servers. Referring to FIG. 1, an example of a first page of user interface 50 is displayed when the digital display terminal is initialized. A content server A is connected to the digital display terminal. First digital content 513 from the content server A is directly displayed on the first page of user interface 50. A second shortcut 53 linking to a content server B and a third shortcut 55 linking to a content sever C are displayed on the first page of user interface 50.

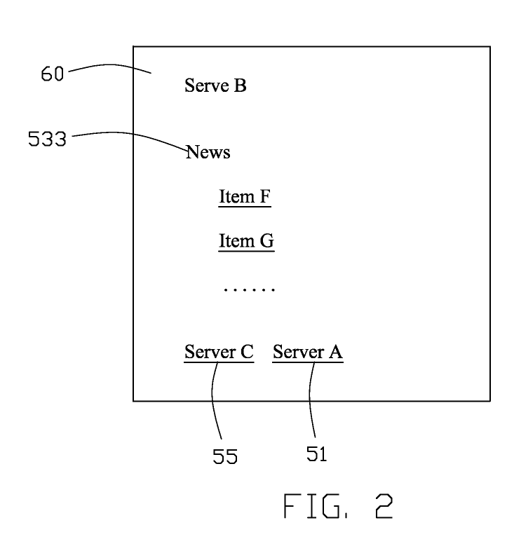

Referring to FIG. 2, the content server B is connected to receive second digital content by activating the second shortcut 53. Second digital content 533 transmitted from the content server B is displayed on a second page of user interface 60. A first shortcut 51 and the third shortcut 55 are displayed on the second page of user interface 60. The first shortcut 51 links to the content server A. At least one shortcut is necessary in the user interface.

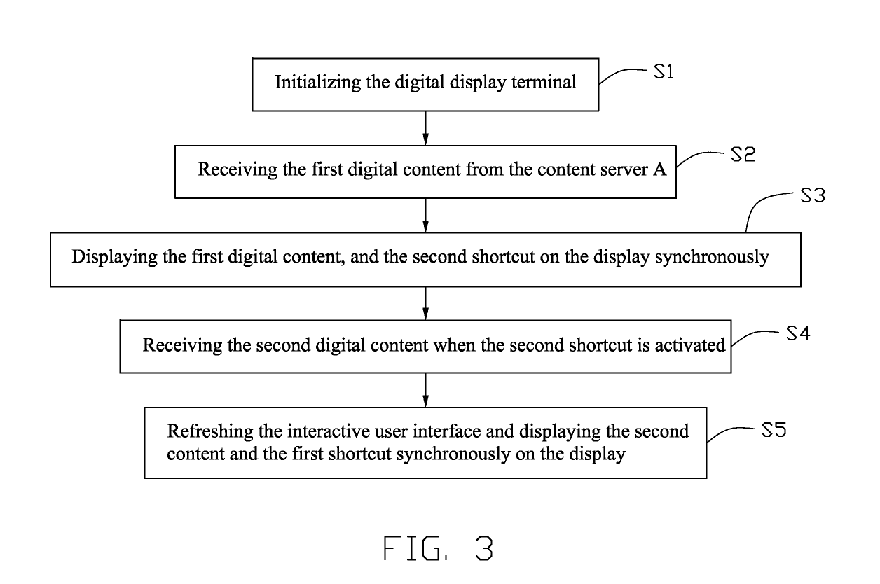

FIG. 3 shows a method for providing interactive user interface on a digital display terminal. In step SI, the digital display terminal is initialized. In step S2, the first digital content is received from the content server A. In step S3, the first digital content and the second shortcut are displayed on the display 10 together. In step S4, the second digital content is received when the second shortcut is activated. In step S5, the interactive user interface is refreshed, the second digital content are displayed and the first shortcut are synchronously shown on the display 10.

The user interface provided in the digital display terminal allows content of one server to be displayed by default upon initialization of the terminal, both content and shortcuts associated with other servers are displayed on one menu, and the shortcut allows switching between servers without requiring access to the server selection menu.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A digital display terminal comprising:
a display; and
a user interface module capable of displaying first digital content and a second shortcut on a first page of an interactive user interface shown on the display, the second shortcut providing access to second digital content, wherein the first digital content is stored on a first content server, and the second digital content is stored on a second content server.

2. The digital display terminal of the claim 1 further comprising a user input module accepting input of the user requirements.

3. The digital display terminal of the claim 2, wherein the user interface module is capable of displaying the second digital content and a first shortcut on a second page of user interface on the display after the second shortcut is activated, wherein the first shortcut links to the first digital content.

4. The digital display terminal of the claim 3, wherein the user input module comprises at least two direction keys accepting input to the first shortcut or the second shortcut.

5. The digital display terminal of the claim 4, wherein the direction keys are set on a remote control.

6. The digital display terminal of the claim 1, wherein the first content server and the second content server are remote servers relative to the digital display terminal.

7. The digital display terminal of the claim 1, wherein the digital display terminal is connected to the first content server and the second content server through the Internet.

8. A method for providing an interactive user interface in a digital display terminal, the digital display terminal comprising a display, the method comprising:
initializing the digital display terminal;
receiving first digital content from a first remote content server; and
displaying the first digital content and a second shortcut on the display, wherein the second shortcut links to second digital content on a second remote content server.

9. The method of claim 8 further comprising receiving second digital content by activating the second shortcut.

10. The method of claim 8 further comprising displaying second digital content and a first shortcut associated with the first remote content server on the display after the second shortcut is activated.

11. The method of claim 8, wherein a user input module is provided accepting input in response to user requirements.

12. The method of claim 11, wherein the user input module comprises at least two direction keys accepting input to the second shortcut.

13. The method of claim 12, wherein the direction keys are set on a remote control.

14. The method of claim 8, wherein the digital display terminal is connected to the first content server and the second content server through the Internet.
